(19) United States
(12) Patent Application Publication
(10) Pub. No.: US 2022/0075661 A1
(43) Pub. Date: Mar. 10, 2022

(54) TECHNOLOGIES FOR SCHEDULING ACCELERATION OF FUNCTIONS IN A POOL OF ACCELERATOR DEVICES

(71) Applicant: Intel Corporation, Santa Clara, CA (US)

(72) Inventors: Hamesh PATEL, Portland, OR (US); Aniket A. BORKAR, Beaverton, OR (US); Prashant SETHI, Folsom, CA (US); Deviusha KRISHNAMOORTHY, Portland, OR (US)

(21) Appl. No.: 17/526,796

(22) Filed: Nov. 15, 2021

Related U.S. Application Data
(63) Continuation of application No. 15/911,321, filed on Mar. 5, 2018.

(51) Int. Cl. G06F 9/50

(52) U.S. Cl. CPC G06F 9/5044; G06F 2209/5011

(57) ABSTRACT

Technologies for scheduling acceleration in a pool of accelerator devices include a compute device. The compute device includes a compute engine to execute an application. The compute device also includes an accelerator pool including multiple accelerator devices. Additionally, the compute device includes an acceleration scheduler logic unit to obtain, from the application, a request to accelerate a function, determine a capacity of each accelerator device in the accelerator pool, schedule, in response to the request and as a function of the determined capacity of each accelerator device, acceleration of the function on one or more of the accelerator devices to produce output data, and provide, to the application and in response to completion of acceleration of the function, the output data to the application. Other embodiments are also described and claimed.

### PRIORITY APPLICATIONS

This application is a continuation of U.S. patent application Ser. No. 15/911,321, filed Mar. 5, 2018, entitled “TECHNOLOGIES FOR SCHEDULING ACCELERATION OF FUNCTIONS IN A POOL OF ACCELERATOR DEVICES ,” which is incorporated in its entirety herewith.

### BACKGROUND

In a typical compute device, such as a server device that is to execute applications on behalf of one or more client devices (e.g., in a data center), the server device may include an accelerator device, such as a field programmable gate array (FPGA) to increase the execution speed of (e.g., accelerate) one or more operations (e.g., functions) of an application. For example, the FPGA may be configured to perform a compression function, an encryption function, a convolution function, or other function that is amenable to acceleration (e.g., able to be performed faster using specialized hardware). Typically, the general purpose processor, executing software (e.g., the applications and/or hardware driver(s)) coordinates the scheduling (e.g., assignment) of functions to the FPGA. The coordination of scheduling functions to be accelerated by the FPGA utilizes a portion of the total compute capacity of the general purpose processor and, as a result, may adversely affect the execution speed of the application and diminish any benefits that would be obtained through accelerating the function with the FPGA. In a compute device that includes multiple accelerator devices, the overhead on the general purpose processor to manage the scheduling of accelerated functions is even greater.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for scheduling acceleration of functions in a pool of accelerator devices in a compute device;

FIG. 2 is a simplified block diagram of at least one embodiment of the compute device of the system of FIG. 1; and

FIGS. 3-5 are a simplified block diagram of at least one embodiment of a method for scheduling acceleration of one or more functions in a pool of accelerator devices that may be performed by the compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

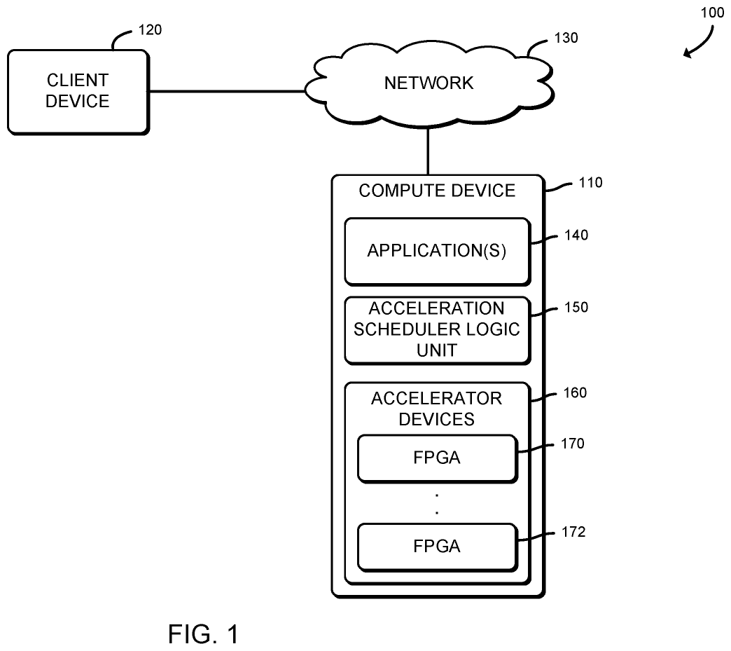

As shown in FIG. 1, an illustrative system 100 for scheduling acceleration in a pool of accelerator devices includes a compute device 110 in communication with a client device 120 through a network 130. In operation, the compute device 110 executes one or more applications 140 (e.g., each in a container or a virtual machine) on behalf of the client device 120 or other client devices (not shown). In doing so, one or more of the applications 140 may request (e.g., through an application programming interface (API) call to an operating system executed by the compute device 110) acceleration of one or more operations (e.g., functions) of the corresponding application 140. The compute device 110 is equipped with a pool of accelerator devices 160 which each may be embodied as any device or circuitry (e.g., a field programmable gate array (FPGA), a co-processor, a graphics processing unit (GPU), etc.) capable of executing operations faster than a general purpose processor. In the illustrative embodiment, the accelerator devices 160 include multiple FPGAs 170, 172. While two FPGAs 170, 172 are shown, it should be understood that in other embodiments, the compute device 110 may include a different number of (e.g., more) FPGAs. The compute device 110 additionally includes an acceleration scheduler logic unit 150, which may be embodied as any dedicated circuitry or device (e.g., a co-processor, an application specific integrated circuit (ASIC), etc.) capable of assigning (e.g., scheduling) the acceleration of functions among the accelerator devices 160. In doing so, the acceleration scheduler logic unit 150 offloads the scheduling functions from a general purpose processor of the compute device 110. As such, compared to typical compute devices that may include one or more accelerator devices, the compute device 110 is able to more efficiently execute applications 140 (e.g., without being burdened with managing the acceleration of functions) and potentially provide a better quality of service (e.g., lower latency, greater throughput).

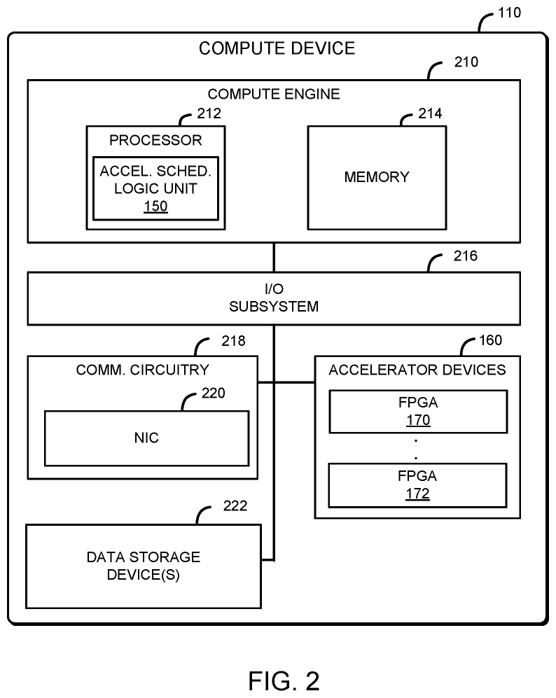

Referring now to FIG. 2, the compute device 110 may be embodied as any type of device capable of performing the functions described herein, including executing an application (e.g., with a general purpose processor), and utilizing the acceleration scheduler logic unit 150 to obtain, from the application 140, a request to accelerate a function, determine a capacity of each accelerator device 160 in the accelerator pool (e.g., the accelerator devices 160), schedule, in response to the request and as a function of the determined capacity of each accelerator device 160, acceleration of the function on one or more of the accelerator devices 160 to produce output data, and provide, to the application 140 and in response to completion of acceleration of the function, the output data to the application. As shown in FIG. 2, the illustrative compute device 110 includes a compute engine 210, an input/output (I/O) subsystem 216, communication circuitry 218, the accelerator devices 160, and one or more data storage devices 222. Of course, in other embodiments, the compute device 110 may include other or additional components, such as those commonly found in a computer (e.g., display, peripheral devices, etc.). Additionally, in some embodiments, one or more of the illustrative components may be incorporated in, or otherwise form a portion of, another component.

The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. In the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein. The processor 212, in the illustrative embodiment, also includes the acceleration scheduler logic unit 150, described above with reference to FIG. 1. In other embodiments, the acceleration scheduler logic unit 150 may be separate from the processor 212 (e.g., on a different die).

The memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include other nonvolatile devices, such as a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, the memory 214 may comprise a transistor-less stackable cross point architecture in which memory cells sit at the intersection of word lines and bit lines and are individually addressable and in which bit storage is based on a change in bulk resistance. In some embodiments, all or a portion of the memory 214 may be integrated into the processor 212. In operation, the memory 214 may store various software and data used during operation such as accelerator device data indicative of a present capacity of each accelerator device 160, bit streams indicative of configurations to enable each accelerator device to perform a corresponding type of function, applications, programs, and libraries.

The compute engine 210 is communicatively coupled to other components of the compute device 110 via the I/O subsystem 216, which may be embodied as circuitry and/or components to facilitate input/output operations with the compute engine 210 (e.g., with the processor 212, the acceleration scheduler logic unit 150, and/or the memory 214) and other components of the compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the memory 214, and other components of the compute device 110, into the compute engine 210.

The communication circuitry 218 may be embodied as any communication circuit, device, or collection thereof, capable of enabling communications over the network 130 between the compute device 110 and another compute device (e.g., the client device 120, etc.). The communication circuitry 218 may be configured to use any one or more communication technology (e.g., wired or wireless communications) and associated protocols (e.g., Ethernet, Bluetooth®, Wi-Fi®, WiMAX, etc.) to effect such communication.

The communication circuitry 218 may include a network interface controller (NIC) 220 (e.g., as an add-in device). The NIC 220 may be embodied as one or more add-in-boards, daughter cards, network interface cards, controller chips, chipsets, or other devices that may be used by the compute device 110 to connect with another compute device (e.g., the client device 120, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the compute device 110 at the board level, socket level, chip level, and/or other levels.

The one or more illustrative data storage devices 222 may be embodied as any type of devices configured for short-term or long-term storage of data such as, for example, memory devices and circuits, memory cards, hard disk drives, solid-state drives, or other data storage devices. Each data storage device 222 may include a system partition that stores data and firmware code for the data storage device 222. Each data storage device 222 may also include one or more operating system partitions that store data files and executables for operating systems.

The client device 120 may have components similar to those described in FIG. 2. The description of those components of the compute device 110 is equally applicable to the description of components of the client device 120 and is not repeated herein for clarity of the description. Further, it should be appreciated that any of the compute device 110 and the client device 120 may include other components, sub-components, and devices commonly found in a computing device, which are not discussed above in reference to the compute device 110 and not discussed herein for clarity of the description.

As described above, the compute device 110 and the client device 120 are illustratively in communication via the network 130, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

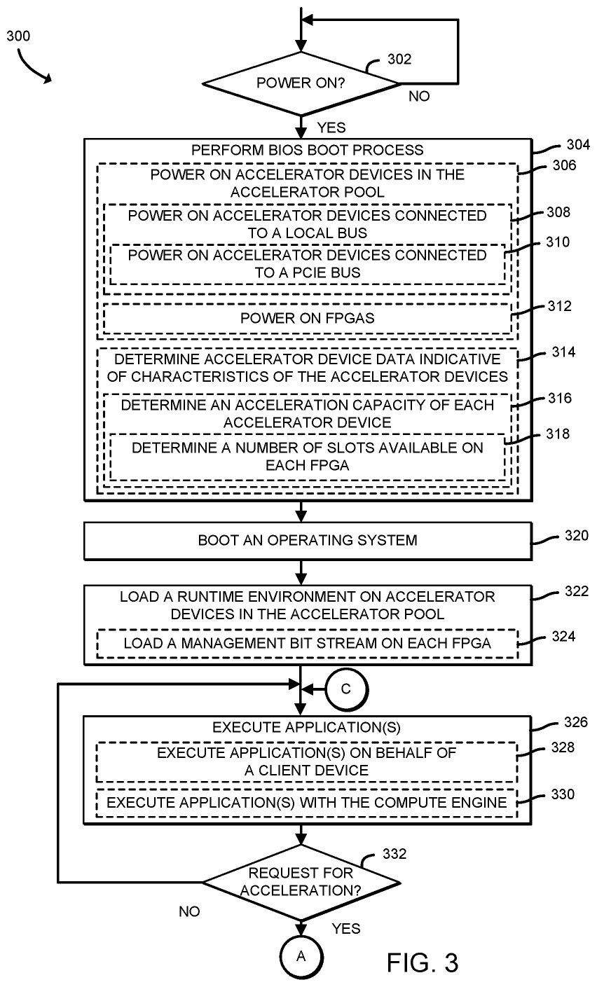

Referring now to FIG. 3, the compute device 110, in operation, may execute a method 300 for scheduling acceleration of functions in a pool of accelerator devices (e.g., the accelerator devices 160). The method 300 begins with block 302, in which the compute device 110 determines whether it has been powered on. If so, the method 300 advances to block 304, in which the compute device 110 performs a basic input output system (BIOS) boot process. In doing so, in the illustrative embodiment, the compute device 110 powers on accelerator devices 160 in the accelerator pool, as indicated in block 306. As indicated in block 308, in the illustrative embodiment, the compute device 110 powers on accelerator devices 160 connected to a local bus of the compute device 110. For example, and as indicated in block 310, the compute device 110 may power on accelerator devices 160 connected to a Peripheral Component Interconnect express (PCIe) bus. In the illustrative embodiment, the compute device 110 powers on multiple FPGAs (i.e., the FPGAs 170, 172), as indicated in block 312. Further, in the boot process and as indicated in block 314, the compute device 110 may determine accelerator device data, which may be any data indicative of characteristics of the accelerator devices 160 (e.g., by querying each accelerator device 160 through the local bus for the data). In doing so, the compute device 110 may determine an acceleration capacity of each accelerator device, as indicated in block 316. For example, and as indicated in block 318, the compute device 110 may determine a number of slots (e.g., separate sets of circuitry or logic capable of being configured to perform a function) in each FPGA 170, 172. In determining the acceleration capacity, the compute device 110 may additionally or alternatively determine a number of operations per second that each accelerator device 160 is capable of performing, a total gate count, or other data indicative of the capacity of the accelerator device 160 to execute a function offloaded from the processor 212 to the accelerator device 160.

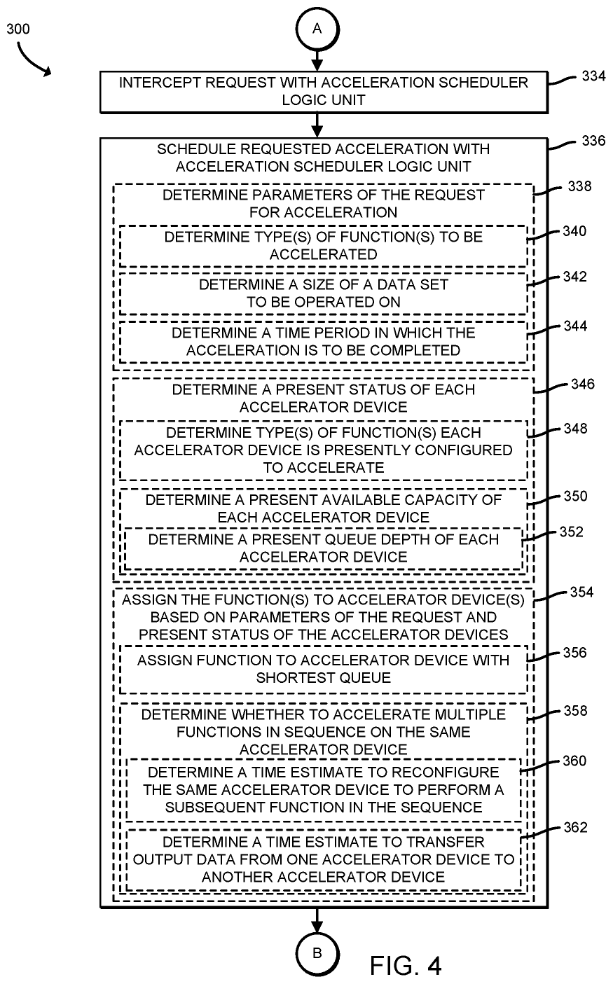

Subsequently, the method 300 advances to block 320, in which the compute device 110 boots the operating system. In doing so, the compute device 110 may provide device data (e.g., accelerator device data) determined during the BIOS boot process to the operating system (e.g., in an advanced control and power interface (ACPI) table). Afterwards, in block 322, the compute device 110 loads a runtime environment on each accelerator device 160 in the accelerator pool. In doing so, the compute device 110 may cause each accelerator device 160 to load a management bit stream (e.g., a set of code indicative of a configuration of gates in an FPGA 170, 172 to implement one or more functions), as indicated in block 324. The management bit stream may enable each FPGA 170, 172 to perform administrative functions in response to requests from the acceleration scheduler logic unit 150 (e.g., to load a bit stream associated with a particular function to be accelerated, to read an input data set into a local memory of the FPGA 170, 172, to send output data to the memory 214 or to another FPGA 170, 172, etc.). In block 326, the compute device 110 executes one or more applications 140. In doing so, the compute device 110 may execute one or more applications 140 on behalf of the client device 120 (e.g., in response to a request from the compute sled 130 for the application to be executed), as indicated in block 328. In the illustrative embodiment, the compute device 110 executes the application(s) 140 with the compute engine 210, as indicated in block 330. In doing so, one or more of the applications 140 may request acceleration, such as by sending a request to the operating system for acceleration of a particular function within the application 140 (e.g., an encryption function, a compression function, a convolution function, etc.). In block 332, the compute device 110 determines whether a request for acceleration has been produced. If not, the method 300 loops back to block 326 in which the compute device 110 continues execution of the application(s) 140. Otherwise (e.g., if a request for acceleration has been produced), the method 300 advances to block 334 of FIG. 4, in which the compute device 110 intercepts (e.g., receives), with the acceleration scheduler logic unit 150, the request for acceleration.

Referring now to FIG. 4, after intercepting the request, the compute device 110 schedules the requested acceleration using the acceleration scheduler logic unit 150 (e.g., offloading the scheduling operations from the processor 212), as indicated in block 336. In doing so, the acceleration scheduler logic unit 150, in the illustrative embodiment, determines parameters of the request for acceleration (e.g., by parsing parameters included in the request), as indicated in block 338. In doing so, and as indicated in block 340, the acceleration scheduler logic unit 150 may determine the type(s) of function(s) to be accelerated. The type of each function (e.g., encryption, compression, convolution, etc.) may be included as a parameter of the request (e.g., as an alphanumeric code or description). In other embodiments, the name of the function may be included in the request, and the acceleration scheduler logic unit 150 may compare the name of the function to a set of data that maps names of functions to types of functions, to determine which type of function is being requested. As indicated in block 342, the acceleration scheduler logic unit 150 may determine a size of a data set to be operated on, such as by reading a parameter of the request that indicates the size (e.g., a number of bytes), by scanning the data set for an indicator of the end of the data set (e.g., a predefined value), or through another method. Additionally or alternatively, the acceleration scheduler logic unit 150 may determine a time period in which the acceleration is to be completed, as indicated in block 344. The acceleration scheduler logic unit 150 may do so by parsing an indicator of a target latency for completing the function, comparing an identifier of the requesting application 140 (e.g., the application that produced the request for acceleration) to a set of target latencies associated with application identifiers, parsing an indication of a priority (e.g., low, medium, high, etc.) from the request and associating the indication of priority with one of a set of predefined latencies, and/or through another method.

Additionally, in scheduling the requested acceleration, the acceleration scheduler logic unit 150, in the illustrative embodiment, determines a present status of each accelerator device 160, as indicated in block 346. In doing so, the compute device 110 may determine the types of functions each accelerator device 160 is presently configured to accelerate (e.g., which bit streams have been loaded by each accelerator device 160), as indicated in block 348. Additionally, the acceleration scheduler logic unit 150 may determine a present available capacity of each accelerator device 160 (e.g., how heavily loaded each accelerator device 160 is), as indicated in block 350. In doing so, and as indicated in block 352, the acceleration scheduler logic unit 150 may determine a present queue depth (e.g., a number of acceleration functions that have not yet been completed) of each accelerator device 160.

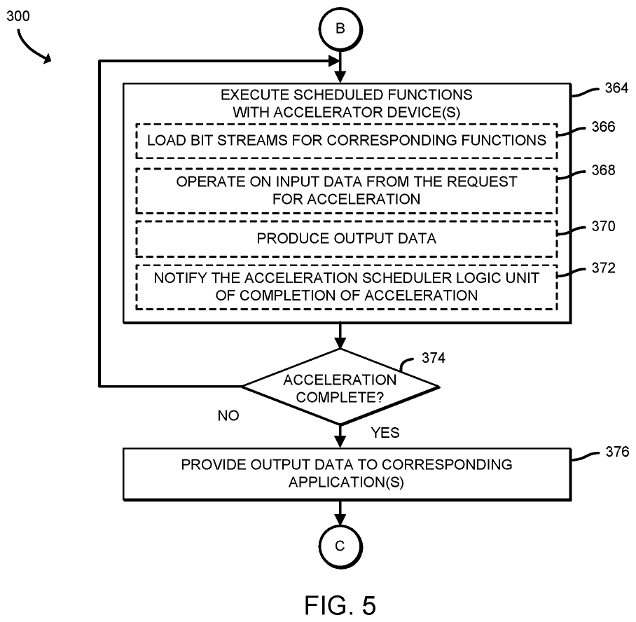

Further, as indicated in block 354, in scheduling the requested acceleration, the acceleration scheduler logic unit 150, assigns the function(s) to be accelerated to the accelerator device(s) 160 based on the parameters of the request (e.g., from block 338) and the present status of the accelerator devices 160 (e.g., from block 346). In doing so, the acceleration scheduler logic unit 150 may assign a function to the accelerator device 160 with the shortest queue depth (e.g., the accelerator device 160 that has the least amount of functions presently assigned to it), as indicated in block 356. The acceleration scheduler logic unit 150 may also match a function with an accelerator device 160 that is already configured to perform the type of function for which acceleration has been requested (e.g., the FPGA 170 has already loaded a bit stream to perform a compression function). Additionally, the acceleration scheduler logic unit 150 may take into account the acceleration capacities of the given accelerator devices 160 (e.g., the capacities determined in block 316), determine an estimated throughput of each accelerator device 160 as a function of the capacities, and potentially determine that an accelerator device 160 having more functions in its queue will still be able to complete acceleration of the requested function sooner than another accelerator device 160 that has fewer functions in its queue (e.g., as a result of the greater throughput). The acceleration scheduler logic unit 150 may also determine whether to accelerate multiple functions associated with a sequence (e.g., encryption followed by compression of a data set) on the same accelerator device 160, as indicated in block 358. In making a determination of whether to assign multiple functions of a sequence to the same accelerator device 160, the acceleration scheduler logic unit 150 may determine a time estimate to reconfigure the same accelerator device to perform a subsequent function in the sequence (e.g., a time required to load a bit stream for a compression operation after performing an encryption operation on the data set), as indicated in block 360. For example, the acceleration scheduler logic unit 150 may record the length of time that elapses each time the accelerator device 160 is to load a bit stream, and determine, as the estimated time period, an average of the recorded time periods. Alternatively (e.g., if data indicative of previous load times is not available) the acceleration scheduler logic unit 150 may use a predefined (e.g., a hard coded) time period that is to be expected of an accelerator device 160 to load a bit stream. As indicated in block 362, the acceleration scheduler logic unit 150 may also determine a time estimate to transfer output data (e.g., data produced by the accelerator device 160 in performing the requested function on the input data set) to another accelerator device (e.g., through a PCIe bus or other local bus). If the estimated time period to load a subsequent bit stream on the same accelerator device 160 is less than the time period to transfer the output data set to another accelerator device 160 (which may already be configured with the bit stream associated with the subsequent function to be performed), then the acceleration scheduler logic unit 150 may determine to perform the functions in the sequence on the same accelerator device 160. After scheduling the requested acceleration, the method 300 advances to block 364 of FIG. 5, in which the compute device 110 executes the scheduled functions with the accelerator devices 160.

Referring now to FIG. 5, in executing the scheduled functions with the accelerator devices 160, the compute device 110, in the illustrative embodiment, loads bit streams onto the accelerator devices 160 for the corresponding functions, as indicated in block 366. Further, the accelerator devices 160 operate on input data from the request(s) for acceleration (e.g., encrypting input data, compressing input data, etc.), as indicated in block 368. Further, the accelerator devices 160 produce output data (e.g., the encrypted form of the data, the compressed form of the data, etc.), as indicated in block 370. Further, the accelerator devices 160 may notify the acceleration scheduler logic unit 150 of completion of acceleration of a function, as indicated in block 372 (e.g., by sending a message to the acceleration scheduler logic unit 150 through the I/O subsystem 218, by setting a predefined value in a register, etc.). In block 374, the acceleration scheduler logic unit 150 determines whether the requested acceleration of a function, or all of the functions in a sequence, is complete. If not, the method 300 loops back to block 364 in which the accelerator devices 160 continue to execute the scheduled functions. Otherwise (e.g., if acceleration is complete), the method 300 advances to block 376, in which the compute device 110 (e.g., the acceleration scheduler logic unit 150) provides the output data to the corresponding application(s) 140 (e.g., the application(s) 140 that requested acceleration), such as by providing each corresponding application 140 with a reference to (e.g., an address of) the output data in memory (e.g., the memory 214). Subsequently, the method 300 loops back to block 326 of FIG. 3, in which the compute device 110 continues execution of the application(s) 140.

### EXAMPLES

Illustrative examples of the technologies disclosed herein are provided below. An embodiment of the technologies may include any one or more, and any combination of, the examples described below.

Example 1 includes a compute device comprising a compute engine to execute an application; an accelerator pool including multiple accelerator devices; and an acceleration scheduler logic unit to (i) obtain, from the application, a request to accelerate a function; (ii) determine a capacity of each accelerator device in the accelerator pool; (iii) schedule, in response to the request and as a function of the determined capacity of each accelerator device, acceleration of the function on one or more of the accelerator devices to produce output data; and (iv) provide, to the application and in response to completion of acceleration of the function, the output data to the application.

Example 2 includes the subject matter of Example 1, and wherein the acceleration scheduler logic unit is further to determine parameters of the request to accelerate a function and wherein to schedule acceleration of the function further comprises to schedule acceleration of the function based on the determined parameters of the request.

Example 3 includes the subject matter of any of Examples 1 and 2, and wherein to determine the parameters of the request comprises to determine one or more of a type of function to be accelerated, a size of a data set to be operated on, or a time period in which acceleration of the function is to be completed.

Example 4 includes the subject matter of any of Examples 1-3, and wherein to determine a capacity of each accelerator device comprises to determine a queue depth associated with each accelerator device.

Example 5 includes the subject matter of any of Examples 1-4, and wherein to schedule acceleration of the function comprises to assign the function to one of the accelerator devices that has the shortest queue depth.

Example 6 includes the subject matter of any of Examples 1-5, and wherein the acceleration scheduler logic unit is further to determine a type of function each accelerator device is presently configured to accelerate and wherein to schedule acceleration of the function comprises to schedule acceleration of the function based additionally on the determined type of function each accelerator device is presently configured to accelerate.

Example 7 includes the subject matter of any of Examples 1-6, and wherein the function is one of multiple functions in a sequence of functions to be accelerated, and the acceleration scheduler logic unit is further to determine whether to accelerate the multiple functions on a single accelerator device in the accelerator pool.

Example 8 includes the subject matter of any of Examples 1-7, and wherein to determine whether to accelerate the multiple functions on a single accelerator device comprises to determine a time estimate to reconfigure the accelerator device for each function in the sequence.

Example 9 includes the subject matter of any of Examples 1-8, and wherein to determine whether to accelerate the multiple functions on a single accelerator device comprises to determine a time estimate to transfer output data from one accelerator device to another accelerator device in the accelerator pool.

Example 10 includes the subject matter of any of Examples 1-9, and wherein each accelerator device in the accelerator pool is a field programmable gate array (FPGA) and the acceleration scheduler logic unit is further to determine a number of slots available on each FPGA.

Example 11 includes the subject matter of any of Examples 1-10, and wherein an accelerator device in the accelerator pool to which the function is scheduled is to load a bit stream to accelerate the function.

Example 12 includes the subject matter of any of Examples 1-11, and wherein the accelerator device is to send, to the acceleration scheduler logic unit, a notification indicative of completion of the acceleration.

Example 13 includes one or more non-transitory machine-readable storage media comprising a plurality of instructions stored thereon that, in response to being executed, cause a compute device to execute, with a compute engine, an application; obtain, from the application and with an acceleration scheduler logic unit, a request to accelerate a function; determine, with the acceleration scheduler logic unit, a capacity of each of multiple accelerator devices in an accelerator pool of the compute device; schedule, with the acceleration scheduler logic unit, in response to the request and as a function of the determined capacity of each accelerator device, acceleration of the function on one or more of the accelerator devices to produce output data; and provide, with the acceleration scheduler logic unit, to the application and in response to completion of acceleration of the function, the output data to the application.

Example 14 includes the subject matter of Example 13, and wherein the plurality of instructions further cause the compute device to determine, with the acceleration scheduler logic unit, parameters of the request to accelerate a function and wherein to schedule acceleration of the function further comprises to schedule acceleration of the function based on the determined parameters of the request.

Example 15 includes the subject matter of any of Examples 13 and 14, and wherein to determine the parameters of the request comprises to determine one or more of a type of function to be accelerated, a size of a data set to be operated on, or a time period in which acceleration of the function is to be completed.

Example 16 includes the subject matter of any of Examples 13-15, and wherein to determine a capacity of each accelerator device comprises to determine a queue depth associated with each accelerator device.

Example 17 includes the subject matter of any of Examples 13-16, and wherein to schedule acceleration of the function comprises to assign the function to one of the accelerator devices that has the shortest queue depth.

Example 18 includes the subject matter of any of Examples 13-17, and wherein the plurality of instructions further cause the compute device to determine, with the acceleration scheduler logic unit, a type of function each accelerator device is presently configured to accelerate and wherein to schedule acceleration of the function comprises to schedule acceleration of the function based additionally on the determined type of function each accelerator device is presently configured to accelerate.

Example 19 includes the subject matter of any of Examples 13-18, and wherein the function is one of multiple functions in a sequence of functions to be accelerated, and wherein the plurality of instructions further cause the compute device to determine, with the acceleration scheduler logic unit, whether to accelerate the multiple functions on a single accelerator device in the accelerator pool.

Example 20 includes the subject matter of any of Examples 13-19, and wherein to determine whether to accelerate the multiple functions on a single accelerator device comprises to determine a time estimate to reconfigure the accelerator device for each function in the sequence.

Example 21 includes the subject matter of any of Examples 13-20, and wherein to determine whether to accelerate the multiple functions on a single accelerator device comprises to determine a time estimate to transfer output data from one accelerator device to another accelerator device in the accelerator pool.

Example 22 includes the subject matter of any of Examples 13-21, and wherein each accelerator device in the accelerator pool is a field programmable gate array (FPGA) and the plurality of instructions further cause the compute device to determine a number of slots available on each FPGA.

Example 23 includes the subject matter of any of Examples 13-22, and wherein the plurality of instructions further cause the compute device to load, with an accelerator device in the accelerator pool to which the function is scheduled, a bit stream to accelerate the function.

Example 24 includes the subject matter of any of Examples 13-23, and wherein the plurality of instructions further cause the compute device to send, with the accelerator device and to the acceleration scheduler logic unit, a notification indicative of completion of the acceleration.

Example 25 includes a compute device comprising circuitry for executing an application; circuitry for obtaining, from the application, a request to accelerate a function; circuitry for determining a capacity of each of multiple accelerator devices in an accelerator pool of the compute device; means for scheduling, in response to the request and as a function of the determined capacity of each accelerator device, acceleration of the function on one or more of the accelerator devices to produce output data; and circuitry for providing to the application and in response to completion of acceleration of the function, the output data to the application.

Example 26 includes a method comprising executing, with a compute engine of a compute device, an application; obtaining, from the application and with an acceleration scheduler logic unit of the compute device, a request to accelerate a function; determining, with the acceleration scheduler logic unit, a capacity of each of multiple accelerator devices in an accelerator pool of the compute device; scheduling, with the acceleration scheduler logic unit, in response to the request and as a function of the determined capacity of each accelerator device, acceleration of the function on one or more of the accelerator devices to produce output data; and providing, with the acceleration scheduler logic unit, to the application and in response to completion of acceleration of the function, the output data to the application.

Example 27 includes the subject matter of Example 26, and further including determining, with the acceleration scheduler logic unit, parameters of the request to accelerate a function and wherein scheduling acceleration of the function further comprises scheduling acceleration of the function based on the determined parameters of the request.

Example 28 includes the subject matter of any of Examples 26 and 27, and wherein determining the parameters of the request comprises determining one or more of a type of function to be accelerated, a size of a data set to be operated on, or a time period in which acceleration of the function is to be completed.

1. One or more non-transitory machine-readable storage media comprising a plurality of instructions stored thereon that, in response to being executed, cause a system to:
schedule, in response to a request from an application through an application programming interface (API) call, acceleration of a function among a plurality of Field Programmable Gate Arrays, to offload execution of the function to the Field Programmable Gate Array from a processor;
store, in a library, a bit stream to enable one or more Field Programmable Gate Arrays to perform the function; and
load the bit stream associated with the function to be accelerated on one or more Field Programmable Gate Arrays.

2. The one or more non-transitory machine-readable storage media of claim 1, wherein the function is accelerated on multiple Field Programmable Gate Arrays.

3. The one or more non-transitory machine-readable storage media of claim 1, wherein the bit stream associated with the function to be accelerated is loaded on one or more Field Programmable Gate Arrays based on one or more of a type of function to be accelerated, a size of a data set to be operated on, or a time period in which acceleration of the function is to be completed.

4. The one or more non-transitory machine-readable storage media of claim 1, wherein the one or more Field Programmable Gate Arrays to perform the function to be accelerated based on a queue depth associated with each of the one or more Field Programmable Gate Arrays.

5. The one or more non-transitory machine-readable storage media of claim 4, wherein the bit stream associated with the function to be accelerated is loaded on a Field Programmable Gate Array that has a shortest queue depth.

6. The one or more non-transitory machine-readable storage media of claim 1, wherein acceleration of the function is scheduled based on a type of function each of the one or more Field Programmable Gate Arrays is presently configured to accelerate.

7. The one or more non-transitory machine-readable storage media of claim 1, wherein the one or more Field Programmable Gate Arrays is to send, a notification indicative of completion of acceleration of the function.

8. A method comprising:
scheduling, in response to a request from an application through an application programming interface (API) call, acceleration of a function among a plurality of Field Programmable Gate Arrays, to offload execution of the function to the Field Programmable Gate Array from a processor;
storing, in a library, a bit stream to enable one or more Field Programmable Gate Arrays to perform the function; and
loading the bit stream associated with the function to be accelerated on one or more Field Programmable Gate Arrays.

9. The method of claim 8, wherein the function is accelerated on multiple Field Programmable Gate Arrays.

10. The method of claim 8, wherein the bit stream associated with the function to be accelerated is loaded on one or more Field Programmable Gate Arrays based on one or more of a type of function to be accelerated, a size of a data set to be operated on, or a time period in which acceleration of the function is to be completed.

11. The method of claim 8, wherein the one or more Field Programmable Gate Arrays to perform the function to be accelerated based on a queue depth associated with each of the one or more Field Programmable Gate Arrays.

12. The method of claim 11, wherein the bit stream associated with the function to be accelerated is loaded on a Field Programmable Gate Array that has a shortest queue depth.

13. The method of claim 8, wherein acceleration of the function is scheduled based on a type of function each of the one or more Field Programmable Gate Arrays is presently configured to accelerate.

14. A system comprising:
a plurality of Field Programmable Gate Arrays;
circuitry to schedule, in response to a request from an application through an application programming interface (API) call, acceleration of a function among the plurality of Field Programmable Gate Arrays, to offload execution of the function to the Field Programmable Gate Array from a processor;
circuitry to store, in a library, a bit stream to enable one or more Field Programmable Gate Arrays to perform the function; and
circuitry to load the bit stream associated with the function to be accelerated on one or more Field Programmable Gate Arrays.

15. The system of claim 14, wherein the function is accelerated on multiple Field Programmable Gate Arrays.

16. The system of claim 14, wherein the bit stream associated with the function to be accelerated is loaded on one or more Field Programmable Gate Arrays based on one or more of a type of function to be accelerated, a size of a data set to be operated on, or a time period in which acceleration of the function is to be completed.

17. The system of claim 14, wherein the one or more Field Programmable Gate Arrays to perform the function to be accelerated based on a queue depth associated with each of the one or more Field Programmable Gate Arrays.

18. The system of claim 17, wherein the bit stream associated with the function to be accelerated is loaded on a Field Programmable Gate Array that has a shortest queue depth.

19. The system of claim 14, wherein acceleration of the function is scheduled based on a type of function each of the one or more Field Programmable Gate Arrays is presently configured to accelerate.

20. The system of claim 14, wherein the one or more Field Programmable Gate Arrays is to send, a notification indicative of completion of acceleration of the function.
